(19) United States
(12) Patent Application Publication
(10) Pub. No.: US 2025/0334818 A1
(43) Pub. Date: Oct. 30, 2025

(54) DESKTOP ELECTRONIC VIDEO MAGNIFIERS

(71) Applicant: HANGZHOU DUKANG TECHNOLOGY CO., LTD., Hangzhou (CN)

(72) Inventors: Xiang YING, Hangzhou (CN); Yu XIE, Hangzhou (CN)

(73) Assignee: HANGZHOU DUKANG TECHNOLOGY CO., LTD., Hangzhou (CN)

(21) Appl. No.: 19/193,954

(22) Filed: Apr. 29, 2025

(30) Foreign Application Priority Data
Apr. 29, 2024 (CN) 202420907573.1

(51) Int. Cl. G02B 27/02; G06F 3/01; G06F 3/04883

(52) U.S. Cl. CPC G02B 27/028; G06F 3/017; G06F 3/04883

(57) ABSTRACT

The present disclosure relates to a desktop electronic video magnifier, including a base, a bracket, and a display, wherein the display and the base are connected to both ends of the bracket respectively, and the bracket includes a gripping portion to be grasped by a user. The present disclosure adopts a combination of the base, the bracket, and the display to form the desktop electronic video magnifier, and provides the user with a part that can be directly grasped under a circumstance of ensuring that an overall reasonable center can be placed in a stable manner. By holding the bracket, the user can directly lift the whole desktop electronic video magnifier for moving and carrying, and keep reliable force during moving simultaneously, greatly reducing a risk of shaking or accidental drops, which is very friendly to visually impaired individuals' experience.

### CROSS-REFERENCE

This application claims priority to the Chinese Patent Application No. 202420907573.1, filed on Apr. 29, 2024, the contents of which are hereby incorporated by reference.

### TECHNICAL FIELD

The present disclosure generally relates to a technical field of artificial vision intelligent devices, and in particular, to desktop electronic video magnifiers.

### BACKGROUND

An electronic video magnifier is a visual aid primarily designed for visually impaired individuals. Market-available electronic video magnifiers typically offer functions such as image capture and adjustable magnification on displays, enabling users to view target content with enhanced clarity.

Desktop electronic video magnifiers currently dominate the market, as exemplified by the detachable sub-screen electronic video magnifier disclosed in Chinese Utility Model Patent CN216217261U. While these products provide stable operation when deployed on flat surfaces, their usage scenarios often require portability. Conventional desktop electronic video magnifiers prioritize operational stability over mobility—the cited patent's electronic video magnifier, for example, requires folding before movement. The unfolded configuration lacks proper gripping points, creating handling difficulties particularly for visually impaired individuals. This may lead to device instability or accidental drops during transport, potentially causing damage. Consequently, existing desktop electronic video magnifiers still present considerable operational inconveniences for daily use by the visually impaired.

Therefore, it is desirable to provide a desktop electronic video magnifier, which can remain stable during carrying by the visually impaired individuals, and reduce a risk of shaking or accidental drops.

### SUMMARY

One of the embodiments of the present disclosure provides a desktop electronic video magnifier, comprising a base, a bracket, and a display, wherein the display and the base are connected to both ends of the bracket respectively, and the bracket includes a gripping portion to be grasped by a user.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a structure of a desktop electronic video magnifier according to some embodiments of the present disclosure;

FIG. 2 is a schematic diagram illustrating a structure of a desktop electronic video magnifier according to some other embodiments of the present disclosure;

FIG. 3 is a schematic diagram illustrating a structure of a desktop electronic video magnifier according to some embodiments of the present disclosure;

FIG. 4 is a schematic diagram illustrating a multi-axis connecting structure according to some embodiments of the present disclosure;

FIG. 5 is a schematic diagram illustrating a split state according to some embodiments of the present disclosure;

FIG. 6 is a flowchart illustrating a process for guiding a user according to some embodiments of the present disclosure; and

FIG. 7 is a flowchart illustrating a process for adjusting an operating parameter according to some embodiments of the present disclosure.

Identified in the drawings: 1, display; 2, bracket; 21, horizontal frame; 22, vertical frame; 23, gripping plate; 24, projecting portion; 25, first camera; 26, light source; 3, base; 31, preset platform; 32, mechanical button; 4, a multi-axis connecting structure; 41, first connecting portion; 411, first through-hole; 42, second connecting portion; 421, second through-hole; 5, distance-viewing rod; 6, external device interface.

### DETAILED DESCRIPTION

The following illustrates the embodiments of the present disclosure by means of particular specific examples, and other advantages and efficacies of the present disclosure can be readily appreciated by those skilled in the art from the contents disclosed herein. The present disclosure may be implemented or applied in different ways, and the details in the present disclosure may be modified or altered based on different points of view and applications without departing from the spirit of the present disclosure. The details of the present disclosure may be modified or altered without departing from the spirit of the present disclosure. It should be noted that the following embodiments and features in the embodiments may be combined with each other without conflict.

It should be noted that the illustrations disposed in the following embodiments illustrate the basic concepts of the present disclosure in a schematic manner only, and the illustrations only show the components related to the present disclosure and are not drawn in accordance with the number, shapes, and sizes of the components in actual implementation. In actual implementation, the type, number, and proportion of each of the components can be changed arbitrarily, and the layout of the components may be more complex.

All directional indications (such as up, down, left, right, forward, backward, lateral, longitudinal, etc.) in the embodiments of the present disclosure are configured only for explaining the relative positional relationship, movement, etc., among the components in a particular attitude, and if the particular attitude changes, the directional indications change accordingly.

Due to installation errors or the like, the parallelism referred to in the embodiments of the present disclosure may actually be an approximate parallelism, and the perpendicularity may actually be an approximate perpendicularity.

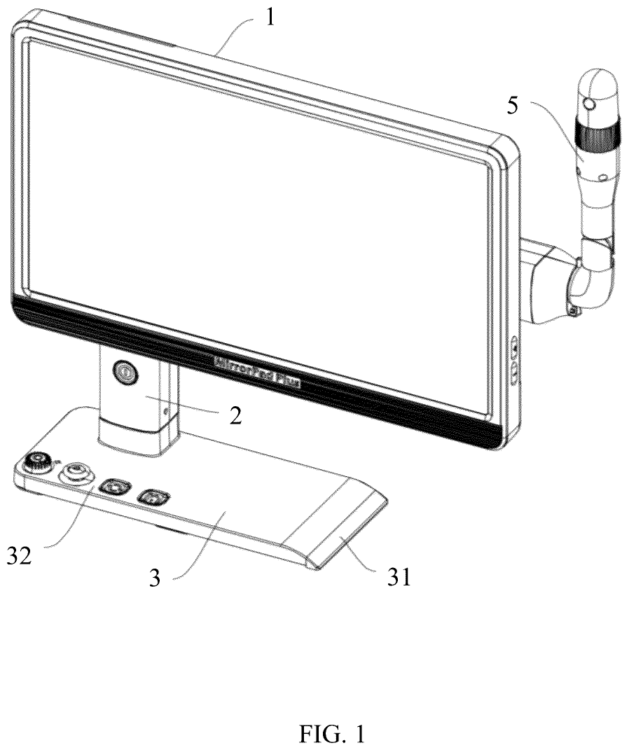

FIG. 1 is a schematic diagram illustrating a structure of a desktop electronic video magnifier according to some embodiments of the present disclosure.

In some embodiments, as shown in FIG. 1, the desktop electronic video magnifier includes a display 1, a bracket 2, and a base 3. The display 1 and the base 3 are connected to both ends of the bracket 2 respectively, and the bracket 2 includes a gripping portion to be grasped by a user.

The gripping portion is a part that the user grasps when lifting the desktop electronic video magnifier. The gripping portion may be disposed at various positions on the desktop electronic video magnifier. For example, the gripping portion may be disposed on a housing of the display 1, on the bracket 2, on the base 3, etc.

In some embodiments, when the gripping portion is disposed on the bracket 2, the gripping portion may be disposed at various positions on the bracket 2. For example, the gripping portion may be disposed in the middle of the bracket 2, etc.

The desktop electronic video magnifier is an electronic device configured to improve visual abilities of visually impaired individuals. A user refers to the visually impaired individual who uses the desktop electronic video magnifier.

In some embodiments, the bracket 2 is configured to support the display 1. The base 3 is configured to hold an object to be assisted in vision, such as carriers with recorded text, images, etc.

In some embodiments, the bracket 2 includes an image acquisition unit, the image acquisition unit is configured to acquire image data of the object and display the image data on the display 1 in an adjustable and enlarged manner, thereby realizing an effect of assisting in vision.

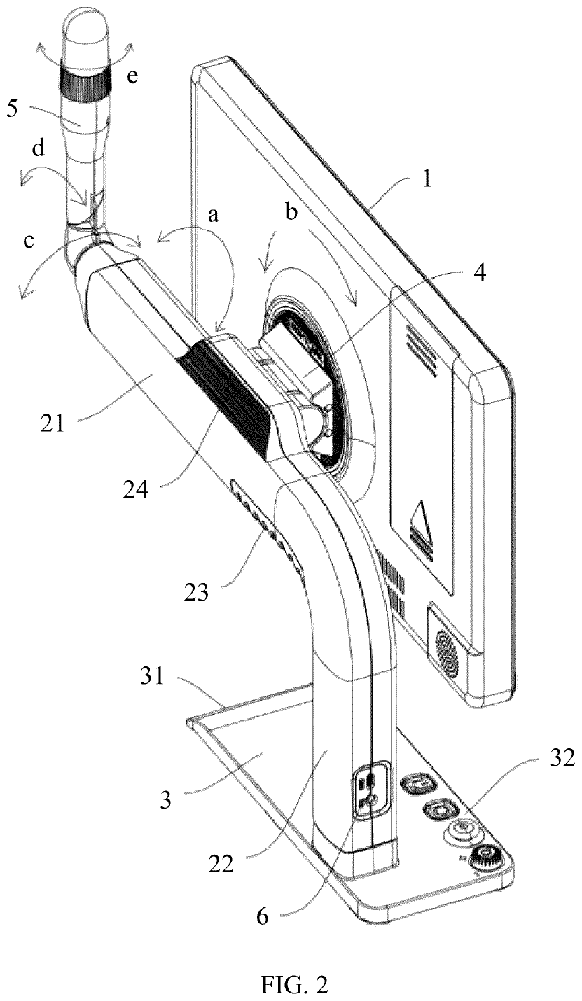

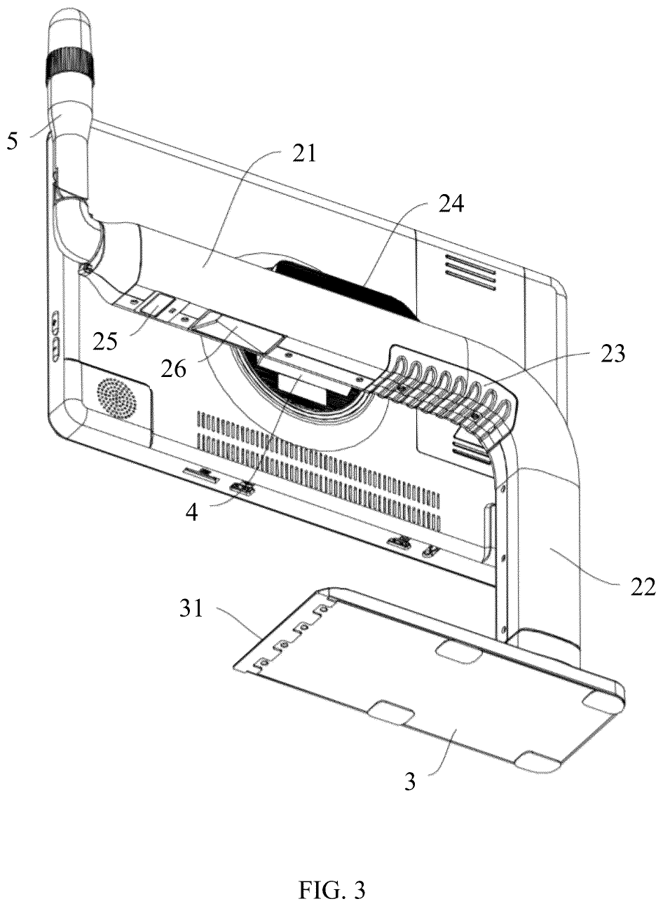

FIG. 2 is a schematic diagram illustrating a structure of a desktop electronic video magnifier according to some other embodiments of the present disclosure. FIG. 3 is a schematic diagram illustrating a structure of a desktop electronic video magnifier according to some embodiments of the present disclosure.

In some embodiments, the bracket 2 includes a horizontal frame 21 and a vertical frame 22, the base 3 is connected to the vertical frame 22, and the display 1 is connected to the horizontal frame 21, as shown in FIG. 2 and FIG. 3.

The base 3 may be connected to the vertical frame 22, and the display 1 may be connected to the horizontal frame 21 in a variety of feasible ways.

In some embodiments, a bottom of the vertical frame 22 is fixedly connected to the base 3 to support the entire bracket 2.

In some embodiments, the bracket 2 may be of different shapes based on different relative positions of the horizontal frame 21 and the vertical frame 22, for example, the bracket 2 may be in an inverted L-shaped structure as illustrated in FIG. 2 and FIG. 3, as another example, the bracket 2 may be in a T-shaped structure, etc.

In some embodiments, the display 1 is connected to the middle of the horizontal frame 21 and supported by the bracket 2, the bracket 2 is formed by two parts in the front-to-back direction that are paired together and secured by clasps, screws, or the like, and the bracket 2 is formed with an inner cavity for wiring.

In some embodiments, the horizontal frame 21 may serve as a user hand gripping position, whereby the user may lift the entire desktop electronic video magnifier by directly grasping the horizontal frame 21.

In some embodiments, as shown in FIG. 2, the bracket 2 is in the inverted L-shaped structure, so that the bracket 2 is able to stabilize and reasonably force when the user lifts up the desktop electronic video magnifier, to ensure the user's stable mobile handling, and to reduce or avoid a risk of shaking or accidental drops.

Some embodiments of the present disclosure adopt the inverted L-shaped structure and provide the user with a portion that can be directly grasped under a circumstance of ensuring that an overall reasonable center can be placed in a stable manner. By holding the bracket, the user can directly lift the whole desktop electronic video magnifier for moving and carrying.

In some embodiments, in order to guide the visually impaired user to grasp reasonably, the bracket 2 further includes a gripping portion to be grasped by the user, for example, the gripping portion may be disposed in the middle of the bracket 2, i.e., the gripping portion is disposed on the horizontal frame 21. The gripping portion may also be disposed at other positions, etc.

In some embodiments, the gripping portion further includes a gripping plate 23 disposed on the gripping plate 21.

The gripping plate 23 is a device disposed on the horizontal frame 21 for easy gripping by the user.

In some embodiments, the gripping plate 23 may be disposed at a predetermined position on the horizontal frame 21 as desired. For example, the gripping plate 23 may be disposed around the horizontal frame 21 as shown in FIG. 2. As another example, the gripping plate 23 may be disposed at a bottom of the horizontal frame 21. The gripping plate 23 may be secured to the horizontal frame 21 by screws, etc.

In some embodiments, the gripping plate 23 is disposed on the horizontal frame 21 in close proximity to the vertical frame 22, i.e., the gripping plate 23 is disposed at an angle between the horizontal frame 21 and the vertical frame 22 to stabilize a center of gravity when the user lifts the desktop electronic video magnifier through the gripping portion.

In some embodiments, the surface of the gripping plate 23 is provided with an undulating pattern for user hand feedback recognition as well as to increase grip friction. The gripping plate 23 may also increase the grip friction by, for example, employing a surface material with a high coefficient of friction.

In some embodiments, the gripping plate 23 is a pressure sensing grip, and an interior of the pressure sensing grip includes a sensor array.

The sensor array refers to a combination of a plurality of pressure sensors provided within the pressure sensing grip. The plurality of pressure sensors are disposed according to a preset rule (e.g., uniformly distributed, etc.) to capture pressure at each portion of the pressure sensing grip.

The pressure sensing grip is configured to monitor hand pressure data exerted by the user on the gripping plate 23 in real time. The hand pressure data includes at least one of a pressure magnitude, a pressure distribution, or the like.

In some embodiments, the gripping plate 23 is provided with a memory alloy or a flexible material internally, and based on the hand pressure data, a shape of the memory alloy or the flexible material is altered to fine-tune a shape of the gripping plate 23 to enhance grip comfort. Fine-tuning the shape of the gripping plate 23 includes adjusting a degree of depression of the surface of the gripping plate 23, adjusting a curvature of the surface of the gripping plate 23, or the like. The greater the hand pressure, the deeper the depression of the surface of the gripping plate 23.

For example, when the gripping plate 23 is provided with the memory alloy internally, based on the hand pressure data, a temperature of the memory alloy is adjusted by an electric heater to deform the memory alloy, thereby fine-tuning the shape of the gripping plate 23.

In some embodiments, the horizontal frame 21 is provided with a first camera 25 and a light source 26, and the first camera 25 and the light source 26 are both disposed downward.

In some embodiments, the image acquisition unit is disposed on the horizontal frame 21, including the first camera 25 and the light source 26 disposed on the horizontal frame 21.

In some embodiments, the first camera 25 and the light source 26 are both disposed downward. That is, the first camera 25 and the light source 26 are both disposed at the bottom of the horizontal frame 21, the first camera 25 faces towards the area in the base 3 where the object to be assisted in vision is placed for capturing an image of the object to be assisted in vision and displaying the image on the display 1, the light source 26 strikes light in an acquisition direction of the first camera 25 to improve the effect of image acquisition.

In some embodiments, the image acquisition unit is disposed at the bottom of the end of the horizontal frame 21, which is away from the vertical frame 22, at which time the first camera 25 and the light source 26 are disposed at the bottom of the horizontal frame 21.

The first camera 25 includes a wide-angle camera, a high-definition camera, etc. The wide-angle camera has an acquisition range that covers a larger area below, enabling the user to acquire a comprehensive image when placing an object to be assisted in vision with a larger acreage below the camera, and the high-definition camera captures high-definition images with a smaller range but a higher degree of clarity than the wide-angle camera. The light source 26 may be an LED, etc.

In some embodiments, the image acquisition unit further includes an adaptive light source disposed in the vicinity of the light source 26 or the gripping plate.

The adaptive light source is a light source with ambient light sensors. The ambient light sensors (e.g., photosensitive elements, etc.) may collect a light intensity of an ambient light, and the adaptive light source may adaptively adjust brightness based on the light intensity of the ambient light to assist visually impaired users in locating the gripping position.

In some embodiments, the first camera 25 and the light source 26 may be annularly disposed on the horizontal frame 21, so that the user may change a shooting area of the first camera 25 by adjusting a position of the first camera 25, and may adjust a fill light effect by adjusting a position of the light source 26. The first camera 25 transmits a captured real-time motion image to the display 1 via a controller.

In some embodiments, the vertical frame 22 is also provided with an external device interface 6. The external device interface 6 is configured to connect an external device, for example, the external device includes an external power supply, a user terminal, or the like.

In some embodiments, the external device interface 6 includes a DC power interface, a type-c phone projection interface, or the like, and the DC power interface is configured to connect an external power line to supply power to the desktop electronic video magnifier, and the phone projection interface is configured to connect electronic devices such as the phone through an external cable to project phone content to the display 1 for display, so as to realizing an effect of assisting in vision of the phone. The phone content includes texts, images, audios, videos, or the like. Android systems under screen projection support an installation of their own developed apps, so as to realize a function of controlling the phone screen in a reverse direction by a direct operation on the display 1, which enlarges a scope of the screen that can be operated.

In some embodiments, the display 1 is a touch display, and when the desktop electronic video magnifier is connected to the external device via the external device interface 6, the user may control the external device by touching the display 1. For example, when the desktop electronic video magnifier is connected to the phone, the user may control the phone screen by touching the display 1.

In some embodiments, the middle of the horizontal frame 21 is also provided with a projecting portion 24, and a surface of the projecting portion 24 has a bar-shaped texture, for the visually impaired individuals to quickly recognize the position of the bracket 2 by hand touch in use, and thus to be able to determine the position of the image acquisition unit or the gripping portion, which is useful for quick and accurate placement of the object to be assisted in vision below the first camera 25.

In some embodiments, the desktop electronic video magnifier further includes a multi-axis connecting structure, the multi-axis connecting structure includes a first connecting portion and a second connecting portion, the first connecting portion is connected to the horizontal frame, the second connecting portion is connected to the display, and the first connecting portion and the second connecting portion are connected by a rotating shaft.

The display 1 is connected to the bracket 2 by a multi-axis connecting structure 4 so that the display 1 may be rotated relative to the bracket 2 in the a-direction and the b-direction (shown by reference to the markings in FIG. 2).

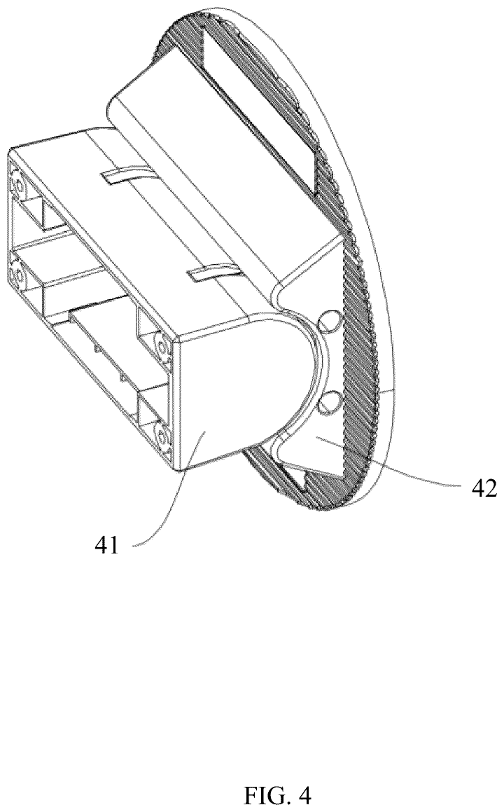

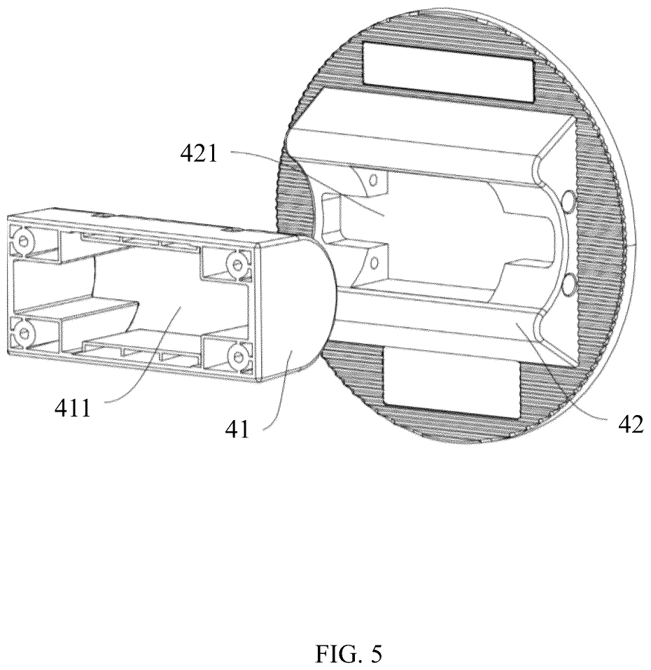

FIG. 4 is a schematic diagram illustrating a multi-axis connecting structure according to some embodiments of the present disclosure. FIG. 5 is a schematic diagram illustrating a split state according to some embodiments of the present disclosure.

In some embodiments, as shown in FIG. 4 and FIG. 5, the multi-axis connecting structure 4 includes a first connecting portion 41 and a second connecting portion 42, the first connecting portion 41 is connected to the bracket 2, and one end of the first connecting portion 41 includes a first half-cylindrical surface. The second connecting portion 42 includes a second half-cylindrical surface for cooperating with the first half-cylindrical surface, the first connecting portion 41 and the second connecting portion 42 cooperates through the two half-cylindrical surfaces, and an internal rotating shaft is disposed in an axis direction of the half-cylindrical surfaces for connection, so that the second connecting portion 42 may rotate relative to the first connecting portion 41 in the a-direction with the axis as the center.

In some embodiments, the first connecting portion 41 is fixedly connected to the horizontal frame 21.

In some embodiments, a disc-shaped connecting portion is disposed on the other side of the second connecting portion 42, and a corresponding circular mounting portion is disposed on the back of the display 1 for cooperating with the disc-shaped connecting portion, and the disc-shaped connecting portion is embedded in the circular mounting portion for connection in ways including, but not limited to, by a rotating shaft or by a bearing disposed in a circumferential direction, so that the display 1 can be rotated in the b-direction relative to the second connecting portion 42 with an axis of the disc-shaped connecting portion as the center, so that a horizontal display screen becomes a vertical display screen by flipping 90 degrees.

In some embodiments, the first connecting portion 41 may be rotated with the horizontal frame 21 as the axis, at which point the display 1 may be rotated with the horizontal frame 21 as the axis.

In some embodiments, the multi-axis connecting structure 4 may collect rotation angles of the first connecting portion 41 and the second connecting portion 42 and upload the rotation angles to the controller, and the controller may adaptively adjust an image displayed in the display 1 based on the rotation angles. For example, when the display 1 is placed vertically, i.e., when a rotation angle of the display 1 with respect to the horizontal frame 21 is close to 90° (e.g., greater than) 70°, the controller controls the display 1 to display the image vertically.

In some embodiments, the first connecting portion 41 is provided with a first through-hole 411 connected within the bracket 2, and the second connecting portion 42 is provided with a second through-hole 421 connected within the display 1.

The first through-hole 411 is a through-hole that allows a cable in the bracket 2 to pass through the first connecting portion 41, and the second through-hole 421 is a through-hole that allows a cable in the display 1 to pass through the second connecting portion 42.

In some embodiments, the first through-hole 411 on the first connecting portion 41 is disposed in a middle of the first half-cylindrical surface and is connected within the bracket 2, and the second through-hole 421 on the second connecting portion 42 is disposed in a middle of the second half-cylindrical surface and is connected within the display 1. The first through-hole 411 may also be disposed at other positions on the first connecting portion 41, and the second through-hole 421 may also be disposed at other positions on the second connecting portion 42.

In some embodiments, the first through-hole 411 and the second through-hole 421 are kept connected. Specifically, when the second connecting portion 42 is rotated in any position of a rotation range in the a-direction relative to the first connecting portion 41, the two through-holes have a sufficient connecting acreage for cables to pass through without destructive extrusion, and thus an internal alignment between the display 1 and the bracket 2 can be avoided from being drastically twisted, extruded, or the like, under any rotation in a range of the display 1 to keep the line healthy and durable.

In some embodiments, a connection of the first connecting portion 41 to the second connecting portion 42 and a connection of the second connecting portion 42 to the display 1 both are damped pivoting connections, enabling the display 1 to be maintained at an arbitrary angular position within a movable range.

In some embodiments, the base 3 needs to be sufficiently large to lower the center of gravity of the desktop electronic video magnifier to maintain the stability of the desktop electronic video magnifier, therefore, when the object to be assisted in vision is placed or shifted below the first camera 25 in use by the user, the object to be assisted in vision may interfere with the base 3, and when the object to be assisted in vision is a thin object such as a piece of paper, it may get stuck in a gap at a bottom of the base 3. Based on this, in some embodiments, an edge of the base 3 may be set as a inclined surface, and the edge of the base 3 is connected to a preset platform 31, and a bottom surface of the preset platform 31 is against a placing surface of the desktop electronic video magnifier, and a top of the preset platform 31 forms an inclined surface with the edge of the base 3, so that the paper may be guided above the base 3 by the inclined surface of the preset platform 31 in movement, instead of being stuck under the base 3.

In some embodiments, the preset table 31 may be slanted. That is, a cross-section of the preset platform 31 is triangular, thereby further reducing a size of the gap at the bottom of the base 3 and improving the user experience.

In some embodiments, the base 3 is further provided with a plurality of operation components for realizing an adjustment of the desktop electronic video magnifier, for example, the operation components include buttons, control levers, or the like, or any combination thereof. The base 3 is provided with four mechanical buttons 32 for controlling display functions of the display 1, including a zoom knob, a direction rocker, a switching button, and a menu button, respectively. The zoom knob is rotatable to realize a zoom-in and zoom-out function of the image in the display 1, and a middle of the zoom knob may be pressed to realize a positioning search function. The direction rocker may be swung in all directions to realize a moving preview function of the zoomed-in image of the display 1. The direction rocker may be pressed, and the moving preview function of the zoomed-in image can be realized in a single press, and when pressed for a long period of time, an OCR function is triggered. The switching button is configured for switching display contents (including display contents of an external phone or display contents of a camera capture) on the display 1 when it is pressed, and may also be configured to switch contents of a single wide-angle camera or contents of a single high-definition camera, or contents of the wide-angle camera and the high-definition camera displayed at the same time in the first camera 25. When the menu button is pressed once, contents of a sub-menu jump out on the display 1, and when the menu button is pressed for a long period of time, a main menu mode is exited.

In some embodiments, a side of the display 1 is also provided with physical buttons for adjusting a volume, or the like.

In some embodiments, the desktop electronic video magnifier further includes a removable fixation assembly. The removable fixation assembly may connect the base 3 to a fixation position on the outside of the base 3 to improve a stability of the desktop electronic video magnifier.

In some embodiments, the desktop electronic video magnifier further includes a distance-viewing rod 5, wherein an end of the distance-viewing rod 5 is connected to the horizontal frame 21, and a second camera is disposed at another end of the distance-viewing rod 5.

The distance-viewing rod 5 is configured to capture an image outside an acquisition range of the first camera 25 via the second camera, in particular a wide-area view image, and display the image on the display 1.

In some embodiments, as shown in FIG. 5, the distance-viewing rod 5 is disposed at the end of the horizontal frame 21 and the distance-viewing rod 5 is in a form of a straight-rod structure, and a connection between the end of the distance-viewing rod 5 and the horizontal frame 21 is a rotating shaft type of connection, which in turn enables the distance-viewing rod 5 to be rotated in the c-direction relative to the horizontal frame 21. The c-direction refers to a direction of rotation with the horizontal frame 21 as the axis.

In some embodiments, a middle of the distance-viewing rod 5 is also provided with a rotating shaft that may bend the distance-viewing rod 5 itself in the d-direction, and a rotating shaft that may rotate the second camera relative to itself in the e-direction (as shown by reference to the markings in FIG. 2), so that the distance-viewing rod 5 is capable of capturing a view angle other than that captured by the first camera 25 below the horizontal frame 21. The d-direction is a direction of rotation with the axis of the rotating shaft of the middle of the distance-viewing rod as the axis. The e-direction is a direction of rotation with the axis of the distance-viewing rod 5 as the axis.

In some embodiments, the distance-viewing rod 5 is a telescopic rod.

In some embodiments, the telescopic rod is disposed between a rotating shaft corresponding to the d-direction and a rotating shaft corresponding to the e-direction. The distance-viewing rod 5 is provided with a motor, a screw, and a screw nut internally, and the screw is driven to rotate by the motor to change a position of the screw nut, so as to realize expansion and contraction of the telescopic rod in a direction of the axis of the distance-viewing rod.

In some embodiments of the present disclosure, the second camera is driven to move by the expansion and contraction of the telescopic rod, which can effectively increase the acquisition range of the second camera.

In some embodiments, the horizontal frame 21 is provided with a limiting block, and the limiting block is located on a circumferential side of the distance-viewing rod 5.

In some embodiments, the limiting block is disposed at the end of the horizontal frame 21 in the c-direction for restricting a rotation range of the distance-viewing rod 5 from turning 360 degrees to avoid excessive twisting of its internal alignment.

In some embodiments, the desktop electronic video magnifier further includes a controller, and the controller is communicatively connected to the base 3, the bracket 2, and the display 1. Connection manners include, but are not limited to, at least one of an electrical connection, a signal connection, or the like.

In some embodiments, the controller is configured to determine a target function based on hand pressure data and a duration of the user, and cause the desktop electronic video magnifier to perform the target function.

The duration is a period of time the user continues to apply pressure.

The target function is a function that the user expects the desktop electronic video magnifier to perform currently. The target function includes at least one of a regular display mode, a multi-partition contrast mode, an OCR speed reading mode, or the like.

The regular display mode means that the display 1 displays a regular enlarged image of the object. The multi-partition contrast mode means that the display 1 displays both an original scaled image and the enlarged image of the object. The OCR speed reading mode means automatically recognizing texts in the image and broadcasting the texts by voice.

In some embodiments, the controller may determine the target function by querying a first preset table based on the hand pressure data and the duration.

The first preset table includes a correspondence between different pressure ranges, different duration ranges, and corresponding functions, and the first preset table may be preset by a technician.

In some embodiments, the pressure ranges may include, from small to large, a light-grip pressure range, a medium-grip pressure range, and a heavy-grip pressure range, with different pressure ranges corresponding to different target functions. For example, when the pressure is in the light-grip pressure range, the desktop electronic video magnifier switches to the regular display mode; when the pressure is in the medium-grip pressure range, the desktop electronic video magnifier switches to the multi-partition contrast mode; and when the pressure is in the heavy-grip pressure range, the desktop electronic video magnifier switches to the OCR speed reading mode.

In some embodiments, similar to the pressure ranges, different duration ranges may correspond to different functions.

In other embodiments, different combinations of the pressure ranges and the duration ranges may correspond to different functions.

In some embodiments, the controller may input the pressure and the duration into the first preset table, determine a corresponding pressure range and a corresponding duration range to obtain a corresponding function, and determine the corresponding function as the target function.

In some embodiments, the first preset table may be customized by the user. For example, the user may select one or more functions, and enter the pressures and the durations corresponding to the different functions by holding the gripping plate 23, and thus obtain the first preset table.

In some embodiments, the construction of the first preset table is also related to user information.

The user information includes, but is not limited to, a gender, an age, a height, a weight, etc. The user information may be manually entered by the user.

In some embodiments, ranges of pressure that may be applied by different users are different, and the controller may preset a plurality of first preset tables for users with different genders, ages, heights, and weights. Based on the user information, the controller may determine the target function through correspond first preset table.

In some embodiments, the user information also includes historical hand pressure data, and the controller may determine, based on the historical hand pressure data, a mean and a standard deviation of historical pressures of the user, and a pressure range that does not differ from the mean by more than one standard deviation is determined as the medium-grip pressure range. On the basis of the medium-grip pressure range, the controller may reduce or increase the pressure, respectively, to obtain the light-grip pressure range or the heavy-grip pressure range, and dynamically updating to obtain the first preset table corresponding to the user.

In some embodiments of this disclosure, the user can select different target functions through different hand pressures and durations to make the operation of the desktop electronic video magnifier easier. The accuracy of the user's selection of the target function can be improved by developing different first preset tables for different users.

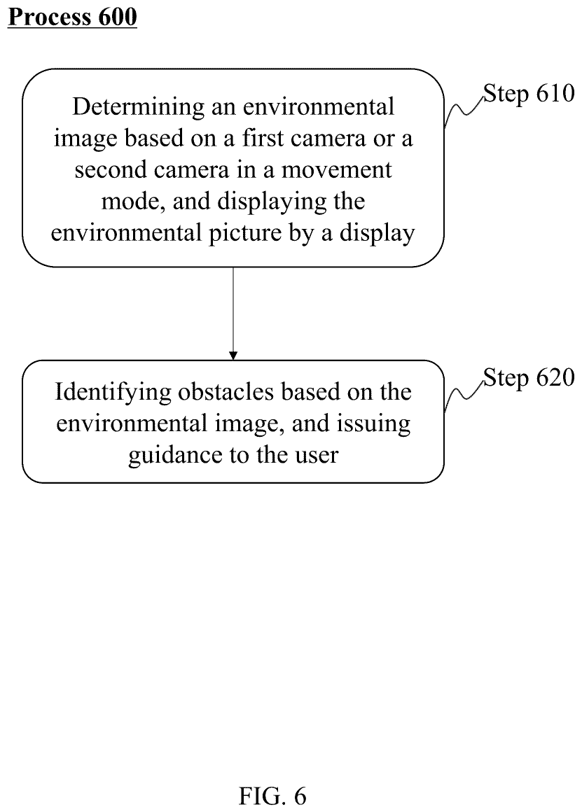

FIG. 6 is a flowchart illustrating a process for guiding a user according to some embodiments of the present disclosure.

As shown in FIG. 6, the process 600 includes the steps described below, and in some embodiments, the process 600 may be performed by a controller.

Step 610, determining an environmental image based on a first camera or a second camera in a movement mode, and displaying the environmental image by a display.

The movement mode refers to a mode in which a user grasps a horizontal frame to lift a desktop electronic video magnifier.

The environmental image refers to a relevant image characterizing the user's surroundings. In some embodiments, the controller may control the first camera or the second camera to capture an image and determine the captured image as the environmental image.

Step 620, identifying obstacles based on the environmental image, and issuing guidance to the user.

In some embodiments, the controller may recognize types, positions, etc., of the obstacles based on the environment image in a variety of ways. For example, the controller may recognize the types, positions, etc., of the obstacles in the environmental image by stereo vision techniques, image segmentation algorithms, feature detection algorithms, etc., and label object frames of the obstacles in the environmental image.

The guidance to the user includes, but is not limited to, voice prompts, vibrations, or the like.

In some embodiments, the controller may generate the voice prompt based on the environmental image and a current position of the user. For example, the voice prompt may be “There is an obstacle 0.5 meters ahead on the left”.

In some embodiments, the gripping plate 23 is provided with a vibration motor internally, and the controller may control the vibration motor to vibrate in different directions to guide the user to move in different directions.

In some embodiments, the bracket 2 further includes a telescopic counterweight module. The controller may adjust a position of the telescopic counterweight module in real time based on a center of gravity offset of the desktop electronic video magnifier.

The telescopic counterweight module is configured to adjust a center of gravity of the desktop electronic video magnifier. The telescopic counterweight module includes a drive unit, a counterweight block, an inertial measurement unit (IMU), etc. The counterweight block is disposed on the bottom of the base 3, and the drive unit may be an electric cylinder, or the like.

In some embodiments, after the user lifts the desktop electronic video magnifier, the IMU may detect a motion state of the desktop electronic video magnifier, and the controller may calculate the center of gravity offset of the desktop electronic video magnifier in real time based on the motion state, and based on the center of gravity offset, control the drive unit to drive the counterweight block to adjust the position of the telescopic counterweight module in real time to maintain a balance of the desktop electronic video magnifier.

The motion state includes a linear velocity, a linear acceleration, an angular velocity, an angular acceleration, or the like, of the desktop electronic video magnifier.

In some embodiments, after lifted by the user, the desktop electronic video magnifier may need to be rotated to achieve force balance. The center of gravity offset is a distance between centers of mass before and after rotation of the desktop electronic video magnifier. The controller may calculate the center of gravity offset based on a center of gravity offset algorithm. The controller may maintain the balance of the desktop electronic video magnifier by driving the counterweight block to slide so that the center of mass of the desktop electronic video magnifier moves in the direction of the rotated center of mass.

In some embodiments, an adjustment magnitude of the telescopic counterweight module is negatively correlated to an age of the user.

The adjustment magnitude is a distance the counterweight block moves in each adjustment. The older the user, the smaller the adjustment magnitude.

Some embodiments of the present disclosure, in the movement mode, can display the environment image in real time through the display, increase the user's safety of use by recognizing the obstacles and issuing guidance to the user, help the user to see clearly the surrounding environment, and can improve user security during movement. By adjusting the position of the telescopic counterweight module in real time, it is able to maintain the balance of the desktop electronic video magnifier during movement and improve the user experience. The center of gravity changes so quickly that older people may not be able to adapt to it, and by adjusting the adjustment magnitude of the telescopic counterweight module based on the user's age, the user experience of older users can be further enhanced.

In some embodiments, a motorized lifting mechanism is disposed between the base 3 and the vertical frame 22, and the motorized lifting mechanism is configured to raise and lower the vertical frame 22. A top or a side surface of the display is further provided with a third camera, and the third camera is configured to obtain a user image of the user. The user image is an image containing the face of the user.

The structure of the motorized lifting mechanism is similar to that of the telescopic rod, and the difference is that the telescopic rod is configured to adjust a position of the second camera, and the motorized lifting mechanism is configured to adjust a height of the display 1. For more descriptions of the telescopic rod, refer to FIG. 2, FIG. 3, and related descriptions thereof.

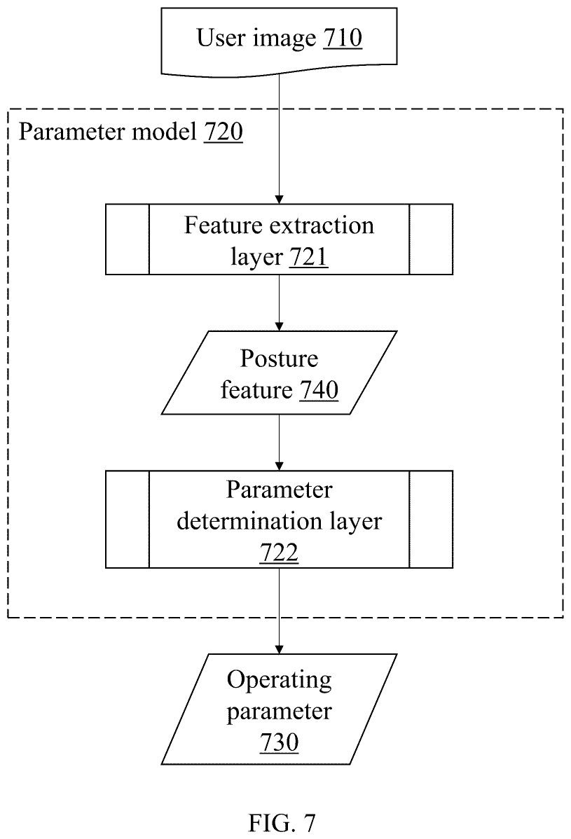

FIG. 7 is a flowchart illustrating a process for adjusting an operating parameter according to some embodiments of the present disclosure.

In some embodiments, as shown in FIG. 7, the controller may adjust an operating parameter 730 of the desktop electronic video magnifier based on a user image 710 by a parameter model 720.

The operating parameter is an operating parameter of the desktop electronic video magnifier. For example, the operating parameter includes a lifting height of a motorized lifting mechanism, display parameters of a display, or the like. The display parameters include at least one of a font size, a screen brightness, or the like.

The parameter model is a model configured to determine the operating parameter. In some embodiments, the parameter model is a machine learning model, e.g., the parameter model may be a convolutional neural network (CNN) model or other user-defined models.

An input of the parameter model 720 includes the user image 710, and an output of the parameter model 720 includes the operating parameter 730.

In some embodiments, the controller may train to obtain the parameter model based on a plurality of first training samples with first labels. The controller may input the first training samples into an initial parameter model, construct a loss function based on an output of the initial parameter model and the first labels, and iteratively update parameters of the initial parameter model based on the loss function. When an iteration end condition is satisfied, the iteration is ended, and a trained parameter model is obtained. Processes for iterative updating include, but are not limited to, gradient descent, and the iteration end condition may be that the loss function converges or a count of iterations reaches a threshold.

The first training sample includes a sample user image, and the first label is an operating parameter of the desktop electronic video magnifier corresponding to the sample user image. The first training sample may be obtained based on historical data. The controller may determine an operating parameter of a sample user corresponding to the sample user image that has been used for the longest period of time in the historical data as the operating parameter of the desktop electronic video magnifier corresponding to the sample user image.

In some embodiments, the parameter model 720 includes a feature extraction layer 721 and a parameter determination layer 722, as shown in FIG. 7.

The feature extraction layer is configured to extract a posture feature of the user. In some embodiments, the feature extraction layer is a machine learning model, e.g., the feature extraction layer may be a convolutional neural network (CNN) model or other user-defined models.

The posture feature is a feature associated with a posture of the user. For example, the posture feature includes at least one of a head position, a facial position, a facial angle, a pupil position, a gesture, or the like. The gesture includes at least one of a waving motion, a handwriting motion, a hand position, or the like.

An input of the feature extraction layer 721 includes the user image 710, and an output of the feature extraction layer 721 includes a posture feature 740.

In some embodiments, the controller may train to obtain the feature extraction layer based on a plurality of second training samples with second labels. The feature extraction layer is trained in a similar manner as the parameter model.

The second training sample includes the sample user image, and the second label is a posture feature corresponding to the sample user image. The second training sample may be obtained based on historical data or network data, and the second label may be obtained by manual labeling.

The parameter determination layer is a model configured to determine the operating parameter. In some embodiments, the parameter determination layer is a machine learning model, e.g., the parameter determination layer may be a convolutional neural network (CNN) model or other user-defined models.

An input of the parameter determination layer 722 includes the pose feature 740, and an output of the parameter determination layer 722 includes the operating parameter 730.

In some embodiments, the controller may train to obtain the parameter determination layer based on a plurality of third training samples with third labels. The parameter determination layer is trained in a similar manner as the parameter model, see above for more.

The third training sample includes the sample posture feature, and the third label includes an operating parameter corresponding to the sample posture feature.

In some embodiments, the controller may determine the second label as the third training sample, and a technician may conduct a pilot test based on the sample posture feature to identify the most comfortable operating parameter from the test results as the third label corresponding to the third training sample.

In some embodiments, the controller may jointly train the feature extraction layer and the parameter determination layer based on a plurality of joint training samples with joint training labels to obtain the parameter model. The controller may input the joint training samples into an initial feature extraction layer, obtain an output of the initial feature extraction layer, input the output of the initial feature extraction layer into an initial parameter determination layer, construct a joint loss function based on the output of the initial parameter determination layer and the joint training labels, and based on the joint loss function, iteratively update parameters of the initial feature extraction layer and the initial parameter determination layer. When an iteration end condition is satisfied, the iteration is ended, and a trained parameter model is obtained.

In some embodiments, the controller may determine the second training sample as the joint training sample and the third label as the joint training label.

Some embodiments of the present disclosure acquire the user image through the third camera, and based on the user image, automatically adjust the lifting height of the motorized lifting mechanism, the font size of the display, the brightness of the display, and other operating parameters, which can adaptively adjust the display in response to the user's current seating position, height, etc., thereof improving the user experience.

In some embodiments, the motorized lifting mechanism is provided with an adjustment button, and the user may manually control the motorized lifting mechanism via the adjustment button.

In some embodiments, in response to an opening of a gesture instruction, the desktop electronic video magnifier may control the desktop electronic video magnifier based on the gesture in the user image. The gesture may be acquired through the feature extraction layer.

The gesture instruction refers to an instruction for controlling the desktop electronic video magnifier through the gesture. In some embodiments, the user may choose whether to turn on the gesture instruction, and when the gesture instruction is turned on, the user may control the desktop electronic video magnifier to perform different operations through different gestures. For example, the user may control the font size, turn a page, switch a target function, or the like, through the gesture.

In some embodiments, the controller may determine, based on the gesture, a control instruction for the desktop electronic video magnifier by querying a second preset table, and the desktop electronic video magnifier performs a corresponding operation based on the control instruction.

The second preset table includes a correspondence between the gesture and the control instruction, and the second preset table may be preset by the technician. For example, double-clicking corresponds to enlarging a font, and swiping corresponds to turning a page. As another example, the user may switch functions of the desktop electronic video magnifier through the gesture.

In some embodiments, in response to the user image including a handwriting action, the controller may ask the user whether or not to switch to a handwriting mode; and in response to the user confirming to switch to the handwriting mode, determine a target form of the distance-viewing rod, and control the distance-viewing rod to rotate or move to the handwriting mode. The handwriting action may be obtained by the feature extraction layer.

In some embodiments, the controller may ask the user whether to switch to the handwriting mode, e.g., by voice.

The target form is configured to characterize a desired position or a desired attitude of the distance-viewing rod in space. For example, the target form includes a rotation angle of the distance-viewing rod along at least one of the directions c, d, and e, a length of extension of the telescopic rod, or the like.

In some embodiments, in response to the user confirming to switch to the handwriting mode, the controller may determine the target form based on the hand position by querying a third preset table and control the distance-viewing rod to rotate or move to the target form.

The third preset table includes a correspondence between the hand position and the target form, and the third preset table may be constructed based on experiments.

In some embodiments of the present disclosure, when the user confirms to switch to the handwriting mode, the distance-viewing rod is automatically rotated or moved to the target form, which can increase user's handwriting range and improve the user experience.

In some embodiments, the controller is further configured to control a phone screen based on the user image in a reverse control mode.

The reverse control mode refers to a mode of controlling the phone screen in a reverse direction by directly operating on the display 1.

In some embodiments, the controller may determine, based on the user image, a posture feature in the user image associated with a process for controlling the phone screen to control the phone screen. The posture feature associated with the process for controlling the phone screen may be obtained through the output of the feature extraction layer.

In some embodiments, the controller is further configured to determine, in the reverse control mode, the operating parameter of the desktop electronic video magnifier based on a screen parameter of the phone screen and the posture feature corresponding to the user image.

The screen parameter refers to a parameter associated with the phone screen, such as whether the phone screen is horizontally or vertically displayed, a screen size of the phone screen, the display parameter, or the like. The controller may be communicatively connected to the phone screen to obtain the screen parameter of the phone screen.

In some embodiments, the controller may construct a feature vector based on the screen parameter and the posture feature; and determine the operating parameter based on a retrieval result of the feature vector in a vector database. The vector database includes a plurality of reference vectors and an operating parameter corresponding to each reference vector. The vector database is constructed based on historical data with a comfort score higher than a scoring threshold. The controller may calculate vector distances between the feature vectors and the reference vectors, and select an operating parameter corresponding to a reference vector with the smallest vector distance as the operating parameter.

In some embodiments, the controller may screen the historical data based on the comfort score, and select a screen parameter and a posture feature of data with a comfort score higher than the scoring threshold as the reference vector; and determine the operating parameter corresponding to the screen parameter and the posture feature as the operating parameter corresponding to the reference vector. The vector database is constructed based the reference vector and the corresponding operating parameter.

In some embodiments, the controller may obtain the comfort score by manual or user evaluation. For example, the controller may perform test experiments for each posture feature and each screen parameter, and thus obtain a manual comfort score. As another example, the controller may obtain a comfort score of the user for the currently displayed phone screen while the user is actually using the phone screen.

Based on the screen parameter of the phone screen and the posture feature corresponding to the user image, the operating parameter of the desktop electronic video magnifier is determined, and the operating parameter can be automatically adjusted to the most comfortable movement parameter for the user based on phone screens and postures of different users, thereby enhancing the user experience.

In some embodiments, the controller is further configured for a display rotation operation, a basic assisting operation, a polymorphic assisting operation based on the distance-viewing rod, a screen projection operation connecting to the user terminal, a multi-screen overlay display operation, or the like.

In some embodiments, the display rotation operation refers to an operation of rotating the display 1 in the b-direction with respect to the second connecting portion 42 with an axis of a disc-shaped connecting portion as a center to realize that the display 1 is turned horizontally and then flipped to a vertical position by 90 degrees, or turned back in the opposite direction. In this process, the controller obtains an action signal of rotation around the axis, and controls the display to adaptively adjust the display content. A horizontal screen state is more suitable for the basic assisting operation, while the vertical screen state is more suitable for screen projection operation connecting to the user terminal (especially phones).

In some embodiments, the basic assisting operation refers to an operation of using the first camera 25 to capture an image of the object to be assisted in vision and display the image on the display 1. Since the displayed content may be magnified or the focus position may be shifted, it is necessary to rotate the zoom knob to zoom in and out the image on the display, press the zoom knob to realize the positioning search function, use the direction rocker to realize the mobile preview of the enlarged image and press and hold to trigger the OCR function when necessary.

In some embodiments, the basic assisting operation may similarly switch to a screen projection interface of the user terminal, except that the phone interface is centered and smaller when it is switched to a horizontal screen, therefore, when switching the display 1 to a vertical screen, a better adaptation of the phone interface and an interface of the display 1 may be obtained.

In some embodiments, the basic assisting operation, the polymorphic assisting operation based on the distance-viewing rod, and the screen projection operation connecting to the user terminal are switched by switching buttons.

In some embodiments, the polymorphic assisting operation based on the distance-viewing rod means that the distance-viewing rod 5 is capable of being rotated in the c-direction with respect to the horizontal frame 21, the second camera is disposed at the other end of the distance-viewing rod 5, a rotating shaft that may bend the distance-viewing rod 5 itself in the d-direction and a rotating shaft that may rotate the second camera relative to itself in the e-direction are disposed at the middle of the distance-viewing rod 5, and the rotating operations in the e and c directions may generate a rotating electric signal to the controller for switching a working mode of the distance-viewing rod. For example, a rotation in the e-direction may be configured for switching between self-timer and look-away modes, when the distance-viewing rod is horizontal in the c-direction, the handwriting mode is switched, compared to the basic assisting function of the first camera, when the user needs to write texts on paper, a scope of operable space is larger, and an interference of handwriting grip is smaller; thus realizing switching between self-timer, long and short focal lengths, and handwriting mode.

In some embodiments, in the screen projection operation connecting to the user terminal, an assisting vision screen supporting the distance-viewing rod and a screen projection interface are displayed on the display of the desktop electronic video magnifier at the same time after superimposing them on each other, realizing that while looking at the screen casting interface of the phone, it is also possible to look at images capture by the camera on the distance-viewing rod in various of modes to further satisfy a need of simultaneous screen projection and assisting in vision.

In some embodiments, when the desktop electronic video magnifier is connected to an external device, the controller may control the desktop electronic video magnifier to charge the external device in a power asynchronous state based on quantities of electricity of the external device and the desktop electronic video magnifier to enable both the external device and the desktop electronic video magnifier to operate in an optimal operating state. For example, the controller selects a slow charging mode when the quantity of electricity of the desktop electronic video magnifier is low (e.g., less than 30%) and when the quantity of electricity of the external device is high (e.g., greater than 90%), and selects a fast charging mode in other cases.

Obviously, the described embodiments are only a part of the embodiments of the present disclosure, and not all of the embodiments. Based on the embodiments in the present disclosure, all other embodiments obtained by those skilled in the art without making creative labor should fall within the scope of protection of the present disclosure.

The basic concepts have been described above, and it is apparent to those skilled in the art that the foregoing detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

Similarly, it should be noted that in order to simplify the presentation of the present disclosure, and aid in the understanding of one or more embodiments of the invention, the foregoing descriptions of embodiments of the present disclosure sometimes group multiple features together in a single embodiment, accompanying drawings, or a description thereof. description thereof. However, this method of disclosure does not imply that the objects of the present disclosure require more features than those mentioned in the claims. Rather, claimed subject matter may lie in less than all features of a single foregoing disclosed embodiment.

Finally, it should be understood that the embodiments described in this disclosure are only used to illustrate the principles of the embodiments of this disclosure. Other deformations may also fall within the scope of this disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A desktop electronic video magnifier, comprising a base, a bracket, and a display, wherein the display and the base are connected to both ends of the bracket respectively, and the bracket includes a gripping portion to be grasped by a user.

2. The desktop electronic video magnifier of claim 1, wherein the bracket includes a horizontal frame and a vertical frame, the base is connected to the vertical frame, and the display is connected to the horizontal frame.

3. The desktop electronic video magnifier of claim 2, wherein the gripping portion includes a gripping plate disposed on the horizontal frame.

4. The desktop electronic video magnifier of claim 3, wherein the gripping plate is a pressure sensing grip, and an interior of the pressure sensing grip includes a sensor array.

5. The desktop electronic video magnifier of claim 2, wherein the horizontal frame is provided with a first camera and a light source, and the first camera and the light source are both disposed downward.

6. The desktop electronic video magnifier of claim 2, further comprising a multi-axis connecting structure, wherein the multi-axis connecting structure includes a first connecting portion and a second connecting portion, the first connecting portion is connected to the horizontal frame, the second connecting portion is connected to the display, and the first connecting portion and the second connecting portion are connected by a rotating shaft.

7. The desktop electronic video magnifier of claim 6, wherein the first connecting portion is provided with a first through-hole connected within the bracket, and the second connecting portion is provided with a second through-hole connected within the display.

8. The desktop electronic video magnifier of claim 1, wherein an edge of the base is connected to a preset platform, a bottom surface of the preset platform is against a placing surface, and a top of the preset platform forms an inclined surface with the edge of the base.

9. The desktop electronic video magnifier of claim 2, further comprising a distance-viewing rod, wherein an end of the distance-viewing rod is connected to the horizontal frame, and a second camera is disposed at another end of the distance-viewing rod.

10. The desktop electronic video magnifier of claim 9, wherein the horizontal frame is provided with a limiting block, and the limiting block is located on a circumferential side of the distance-viewing rod.

11. The desktop electronic video magnifier of claim 9, wherein the distance-viewing rod is a telescopic rod.

12. The desktop electronic video magnifier of claim 2, wherein the vertical frame is provided with an external device interface.

13. The desktop electronic video magnifier of claim 1, further comprising a controller, wherein the controller is communicatively connect to the base, the bracket, and the display, and the controller is configured to:
determine a target function based on hand pressure data and a duration of the user, and cause the desktop electronic video magnifier to perform the target function.

14. The desktop electronic video magnifier of claim 13, wherein the controller is further configured to:
determine an environmental image based on a first camera or a second camera in a mobile mode, and display the environmental image by the display; and
identify obstacles based on the environmental image, and issue guidance to the user.

15. The desktop electronic video magnifier of claim 14, wherein the bracket further includes a telescopic counterweight module, and the controller is further configured to:
adjust a position of the telescopic counterweight module in real time based on a center of gravity offset of the desktop electronic video magnifier.

16. The desktop electronic video magnifier of claim 13, wherein the bracket includes a horizontal frame and a vertical frame, a motorized lifting mechanism is disposed between the base and the vertical frame, and the motorized lifting mechanism is configured to raise and lower the vertical frame;
a top or a side surface of the display is further provided with a third camera, and the third camera is configured to obtain a user image of the user; and
the controller is further configured to: adjust an operating parameter of the desktop electronic video magnifier based on the user image by a parameter model, the parameter model being a machine learning model.

17. The desktop electronic video magnifier of claim 16, wherein the controller is further configured to:
in response to an opening of a gesture instruction, control the desktop electronic video magnifier based on a gesture in the user image.

18. The desktop electronic video magnifier of claim 2, further comprising a distance-viewing rod, wherein the controller is further configured to:
in response to the user image including a handwriting action, ask the user whether to switch to a handwriting mode; and
in response to determining to switch to the handwriting mode, determine a target form of the distance-viewing rod and control the distance-viewing rod to rotate or move to the target form.

19. The desktop electronic video magnifier of claim 13, wherein the controller is further configured to: control a phone screen based on a user image in a reverse control mode.

20. The desktop electronic video magnifier of claim 19, wherein the controller is further configured to: determine, in the reverse control mode, an operating parameter of the desktop electronic video magnifier based on an image parameter of the phone screen and a posture feature corresponding to the user image.
